(19) United States
(12) Patent Application Publication
(10) Pub. No.: US 2025/0389981 A1
(43) Pub. Date: Dec. 25, 2025

(54) OPTICAL WAVEGUIDE ELEMENT, AND OPTICAL MODULATION DEVICE AND OPTICAL TRANSMISSION APPARATUS USING SAME

(71) Applicant: SUMITOMO OSAKA CEMENT CO., LTD., Tokyo (JP)

(72) Inventors: Yuji HAYAMI, Tokyo (JP); Masayuki MOTOYA, Tokyo (JP)

(73) Assignee: SUMITOMO OSAKA CEMENT CO., LTD., Tokyo (JP)

(21) Appl. No.: 18/843,253

(22) PCT Filed: Mar. 30, 2022
(86) PCT No.: PCT/JP2022/016291

§ 371 Date: Apr. 14, 2025

(51) Int. Cl. G02F 1/035; G02F 1/01

(52) U.S. Cl. CPC G02F 1/035; G02F 1/0121; G02F 2201/122

(57) ABSTRACT

An object of the present invention is to provide an optical waveguide device that has an excellent high-frequency characteristic and that is also favorable for forming a pattern of a resin layer covering an optical waveguide and bonding a feeding line to an electrode. An optical waveguide device of the present invention includes an optical waveguide (10) formed on a substrate (1), and a signal electrode(S) and a ground electrode (G) disposed on the substrate (1), in which each electrode of the signal electrode(S) and the ground electrode (G) is formed with a plurality of tiers of electrode layers (30, 31) excluding an underlayer, and at least two electrode layers among the plurality of tiers of electrode layers have different surface roughness.

### TECHNICAL FIELD

The present invention relates to an optical waveguide device, and an optical modulation device and an optical transmission apparatus using the same, and particularly to an optical waveguide device including an optical waveguide formed on a substrate and a signal electrode and a ground electrode disposed on the substrate.

### BACKGROUND ART

In the field of optical measurement technology or in the field of optical communication technology, optical waveguide devices such as an optical modulator using a substrate having an electro-optic effect have been widely used. In a general optical waveguide device, an optical waveguide is formed on a substrate of lithium niobate (LN) or the like having an electro-optic effect, and an electrode that applies an electric field to the optical waveguide is formed on the substrate.

In order to increase efficiency of the electric field applied to the optical waveguide, a signal electrode and a ground electrode into which a high-frequency signal is input employs a configuration of configuring an electrode by laminating a plurality of electrode layers and causing a part of the electrode layers to protrude to a side closer to the optical waveguide, as illustrated in Patent Literature No. 1. By configuring the electrodes with the plurality of electrode layers and adjusting a thickness of each electrode layer or an electrode clearance, a propagation velocity or impedance of a modulation signal can also be adjusted.

As a method of forming each electrode layer, various methods such as a plating method, a vapor deposition method, and a sputtering method have been used. In a case where the thickness of the electrode layer is increased above several μm, the plating method is generally used. However, the plating method has a problem in that surface roughness of the electrode layer is increased compared to other methods. Even in the plating method, performing electroplating with small current density per unit area increases the surface roughness of the electrode.

In a case where the surface roughness of the electrode is increased, a conductor loss is increased during propagation of the modulation signal, and this causes deterioration in a high-frequency characteristic. Particularly, in a case where the surface roughness of the electrode layer having a protruding shape to the side closer to the optical waveguide is increased, an effect on the high-frequency characteristic is also increased.

On the other hand, a configuration of bending the optical waveguide is also employed in order to achieve size reduction of the optical modulator. In such an optical waveguide device, light confinement strength of the optical waveguide needs to be increased in order to reduce a curvature of a bent portion of the optical waveguide. For example, in a ridge optical waveguide, in a case where a width of the optical waveguide is also reduced to approximately 1 μm, roughness of a surface of the optical waveguide significantly affects a propagation loss of a light wave. In order to solve such a problem, a resin layer is formed to cover the optical waveguide in Patent Literature No. 2.

For example, a photosensitive resin is used as the resin layer. A liquid resin material is applied and is then photocured to form a resin layer having a desired pattern. In a case where there is an electrode layer that is caused to protrude to the side closer to the optical waveguide as in Patent Literature No. 1, the photosensitive resin is in contact with the electrode layer. In a case where the surface roughness of the electrode layer is high, air bubbles enter a boundary surface between the resin and the electrode, and adhesiveness is decreased. Accordingly, it is difficult to form the desired pattern.

On the other hand, a wire, a flip-chip, or the like is bonded to each electrode in order to apply an electrical signal including the modulation signal. In performing wire bonding or flip-chip bonding, the surface roughness of the electrode needs to be increased to a certain degree or higher in order to secure sufficient bonding connection strength.

### CITATION LIST

### Patent Literature

[Patent Literature No. 1] Japanese Laid-open Patent Publication No. 2019-174698
[Patent Literature No. 2] Japanese Patent Application No. 2021-050409 (filing date: Mar. 24, 2021)

### SUMMARY OF INVENTION

### Technical Problem

An object to be solved by the present invention is to solve the above problem and provide an optical waveguide device that has an excellent high-frequency characteristic and that is also favorable for forming a pattern of a resin layer covering an optical waveguide and bonding a feeding line to an electrode. It is also an object to provide an optical modulation device and an optical transmission apparatus using the optical waveguide device.

### Solution to Problem

In order to solve the object, an optical waveguide device of the present invention, and an optical modulation device and an optical transmission apparatus using the same have the following technical features.

(1) An optical waveguide device includes an optical waveguide formed on a substrate, and a signal electrode and a ground electrode disposed on the substrate, in which each electrode of the signal electrode and the ground electrode is formed with a plurality of tiers of electrode layers excluding an underlayer, and at least two electrode layers among the plurality of tiers of electrode layers have different surface roughness.

(2) In the optical waveguide device according to (1), surface roughness of an electrode layer forming a narrowest part between the signal electrode and the ground electrode is lower than surface roughness of at least another electrode layer.

(3) In the optical waveguide device according to (1) or (2), surface roughness of at least one electrode layer among the plurality of tiers of electrode layers is lower than surface roughness of a part in which a feeding line is connected to the signal electrode and the ground electrode by bonding.

(4) In the optical waveguide device according to (2), the electrode layer forming the narrowest part between the signal electrode and the ground electrode is an electrode layer of a lowermost tier.

(5) In the optical waveguide device according to (2), in the electrode layer forming the narrowest part between the signal electrode and the ground electrode, surface roughness of a side surface where the signal electrode and the ground electrode face each other is lower than surface roughness of an upper surface of the electrode layer.

(6) In the optical waveguide device according to (1), surface roughness of a side surface where the signal electrode and the ground electrode face each other is lower than surface roughness of an upper surface of an electrode layer of an uppermost tier.

(7) In the optical waveguide device according to (1), in an electrode layer forming a narrowest part between the signal electrode and the ground electrode, surface roughness of an upper surface of the electrode layer is in a range of 0.1 nm to 100 nm.

(8) In the optical waveguide device according to (1), in an electrode layer forming a narrowest part between the signal electrode and the ground electrode, surface roughness of a side surface where the signal electrode and the ground electrode face each other is lower than surface roughness of an upper surface of the electrode layer.

(9) In the optical waveguide device according to (1), roughness of an upper surface of an electrode layer of an uppermost tier is in a range of 100 nm to 1000 nm.

(10) In the optical waveguide device according to (1), in an electrode layer other than an electrode layer forming a narrowest part between the signal electrode and the ground electrode, surface roughness of a side surface where the signal electrode and the ground electrode face each other is lower than surface roughness of an upper surface of the electrode layer.

(11) An optical modulation device including the optical waveguide device according to any one of (1) to (10), a case accommodating the optical waveguide device, and an optical fiber through which a light wave is input into the optical waveguide or output from the optical waveguide.

(12) In the optical modulation device according to (11), the optical waveguide device includes a modulation electrode that modulates the light wave propagating through the optical waveguide, and an electronic circuit that amplifies a modulation signal to be input into the modulation electrode of the optical waveguide device is provided inside the case.

(13) An optical transmission apparatus includes the optical modulation device according to (11) or (12), and an electronic circuit that outputs a modulation signal causing the optical modulation device to perform a modulation operation.

### Advantageous Effects of Invention

In the present invention, an optical waveguide device includes an optical waveguide formed on a substrate, and a signal electrode and a ground electrode disposed on the substrate, in which each electrode of the signal electrode and the ground electrode is formed with a plurality of tiers of electrode layers excluding an underlayer, and at least two electrode layers among the plurality of tiers of electrode layers have different surface roughness. Thus, surface roughness suitable for a role of each electrode layer can be selected, and improvement in a high-frequency characteristic, removal of air bubbles in a resin layer, and furthermore, securing of bonding connection strength of a feeding line and the like can be implemented.

Surface roughness of an electrode layer forming the narrowest part between the signal electrode and the ground electrode is lower than surface roughness of at least another electrode layer. Thus, a conductor loss during propagation of a modulation signal can be suppressed, and a high-frequency characteristic can be improved. Even in a case where a resin layer adheres to the electrode layer forming the narrowest part, air bubbles in the resin layer are unlikely to remain on a surface of the electrode layer, and a desired pattern can be formed.

Surface roughness of at least one electrode layer among the plurality of tiers of electrode layers is lower than surface roughness of a part in which a feeding line is connected to the signal electrode and the ground electrode by bonding. Thus, bonding connection strength of the feeding line can be further increased.

### BRIEF DESCRIPTION OF DRAWINGS

FIG. 1 is a cross-sectional view illustrating a first example related to an optical waveguide device of the present invention.

FIG. 2 is a cross-sectional view illustrating a second example related to the optical waveguide device of the present invention.

FIG. 3 is a cross-sectional view illustrating a third example related to the optical waveguide device of the present invention.

FIG. 4 is a cross-sectional view illustrating a fourth example related to the optical waveguide device of the present invention.

FIG. 5 is a cross-sectional view illustrating a fifth example related to the optical waveguide device of the present invention.

FIG. 6 is a plan view illustrating a sixth example related to the optical waveguide device of the present invention.

FIG. 7 is a plan view for describing an optical modulation device and an optical transmission apparatus of the present invention.

### DESCRIPTION OF EMBODIMENTS

Hereinafter, an optical waveguide device of the present invention will be described in detail using preferred examples.

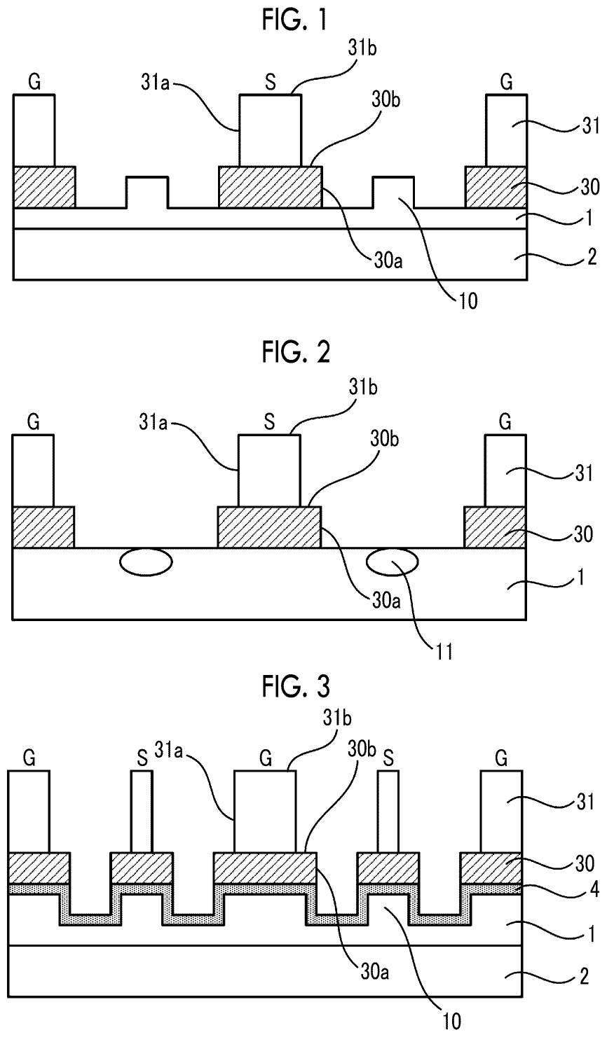

As illustrated in FIGS. 1 to 6, in the present invention, an optical waveguide device includes an optical waveguide 10 formed on a substrate 1, and a signal electrode S and a ground electrode G disposed on the substrate, in which each electrode of the signal electrode S and the ground electrode G is formed with a plurality of tiers of electrode layers (30 and 31) excluding an underlayer, and at least two electrode layers among the plurality of tiers of electrode layers have different surface roughness.

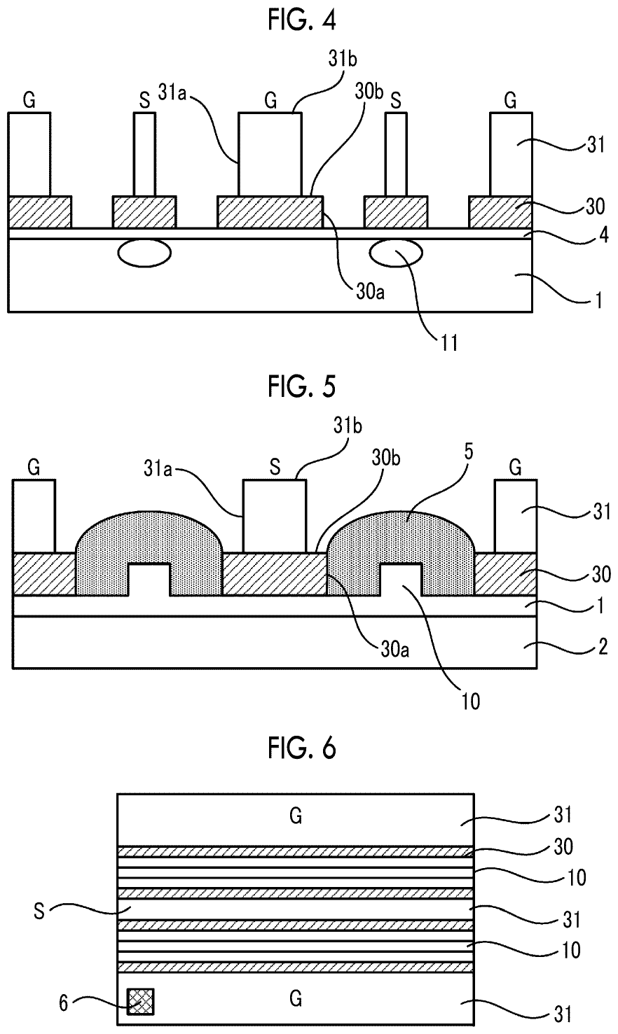

As a material of the substrate 1 that has an electro-optic effect and that is used in the optical waveguide device of the present invention, substrates of lithium niobate (LN), lithium tantalate (LT), lead lanthanum zirconate titanate (PLZT), and the like or base materials obtained by doping these substrate materials with magnesium can be used. Alternatively, vapor-phase growth films and the like formed of these materials can be used. FIGS. 1, 2, 5, and 6 illustrate examples of an X-cut substrate, and FIGS. 3 and 4 illustrate examples of a Z-cut substrate.

In order to achieve velocity matching between a microwave of a modulation signal and a light wave, a thickness of the substrate 1 on which the optical waveguide is formed can be set to 10 μm or lower, more preferably 5 μm or lower, and still more preferably 1 μm or lower. In such a thin substrate, a reinforcing substrate 2 may be adhesively fixed to a lower side of the substrate 1 through direct joining or an adhesive layer of resin or the like in order to increase mechanical strength. As the reinforcing substrate to be directly joined, a substrate including an oxide layer of a material, for example, crystal or glass, that has a lower refractive index than the optical waveguide and the substrate on which the optical waveguide is formed and that has a similar coefficient of thermal expansion to the optical waveguide or the like is preferably used. A composite substrate obtained by forming a silicon oxide layer on a silicon substrate and a composite substrate obtained by forming a silicon oxide layer on an LN substrate, which are abbreviated to SOI and LNOI, can also be used.

The “substrate on which the optical waveguide is formed” of the present invention is referred to as the substrate 1 including not only a substrate constituting an optical waveguide part but also the substrate 1 integrated with the reinforcing substrate 2.

As a method of forming the optical waveguide 10, a rib optical waveguide obtained by forming a part corresponding to the optical waveguide to have a protruding shape in the substrate by, for example, etching the substrate 1 or forming grooves on both sides of the optical waveguide can be used, as illustrated in FIGS. 1, 3, and 5. In a case of using the above substrate of a thin plate, a height of the rib optical waveguide is set to be 4 μm or lower, more preferably 3 μm or lower, and still more preferably 1 μm or lower or 0.4 μm or lower. Alternatively, a vapor-phase growth film can be formed on the reinforcing substrate, and the film can be processed to have a shape of the optical waveguide.

As another optical waveguide 11, a high-refractive index part can be formed on a surface of the substrate using a method of thermally diffusing Ti or the like in the substrate 1, a proton exchange method, or the like, as illustrated in FIGS. 2 and 4. Ti or the like can also be thermally diffused in the rib optical waveguide to strengthen light confinement.

In order to suppress a propagation loss caused by roughness of the surface of the rib optical waveguide, a resin film 5 that covers the optical waveguide may be provided, as illustrated in Patent Literature No. 2 or FIG. 5. The resin film is configured with a permanent resist film or the like, and a material having a lower refractive index than the optical waveguide is used for the resin film. In a case where there is an electrode that is disposed across the optical waveguide, the resin film also functions as a buffer layer (protective film).

In order to suppress a pyroelectric effect of the substrate 1 or suppress absorption of the light wave propagating through the optical waveguide, a buffer layer can be disposed on the substrate 1 on which the optical waveguides (10 and 11) are formed, as illustrated in FIGS. 3 and 4. Various materials such as Si and SiOz can be used for the buffer layer.

An electrode is formed on the substrate 1. The electrode includes a modulation electrode consisting of a signal electrode and a ground electrode, a bias electrode for applying a bias voltage, and the like. A high-frequency signal is applied to the modulation electrode. Thus, the modulation electrode is configured as a laminated body in which electrode layers are laminated, as illustrated in Patent Literature No. 1. Accordingly, a clearance between the signal electrode and the ground electrode can be changed by a position in a height direction. Electric field efficiency of applying the electric field to the optical waveguide can be increased, and impedance or the like can also be adjusted.

While illustration is not provided in FIGS. 1 to 5, an underlayer of Ti, Nb, or the like is provided between the electrode layer 30 of the lowermost layer and the substrate 1 or the buffer layer disposed on the substrate 1 to increase adhesion strength between the electrode and the substrate. The “electrode layer” in the present invention does not include the underlayer.

As a feature of the optical waveguide device of the present invention, at least two electrode layers among the plurality of tiers of electrode layers have different surface roughness in the electrode configured with the plurality of tiers of electrode layers (30 and 31), as illustrated in FIGS. 1 to 6. While two tiers of electrode layers are illustrated in the drawings, three or more tiers of electrode layers may be used in the present invention. While an electrode layer closest to the signal electrode S and the ground electrode G generally corresponds to the electrode layer of the lowermost tier close to the optical waveguide, the present invention is not limited to this, and other parts may be close to the signal electrode S and the ground electrode G, as necessary.

Various methods such as a plating method, a vapor deposition method, and a sputtering method can be employed as a method of forming the electrode layers. In order to adjust surface roughness of the electrode layers that is a feature of the present invention, an appropriate forming method suitable for each electrode layer is employed. In the plating method, in a case of using electroplating, the surface roughness of the electrode layers can be decreased by increasing current density per unit area.

Generally, surface roughness of a formed film body is increased in an order of the sputtering method, the vapor deposition method, and the plating method. In a case where the sputtering method or the vapor deposition method is used, even the same method results in formation of a dense film and a decrease in the surface roughness of the film body in a case where a forming speed of the electrode layer is low. On the other hand, in a case of forming the electrode layers using the plating method, particularly electroplating, the surface roughness of the film body is decreased by increasing the current density per unit area to increase a forming speed.

Furthermore, in a case of forming the electrode layers in an opening part of a resist pattern, surface roughness of a part in contact with the resist film (side surfaces of the electrode layers) is set to be lower than surface roughness of a part (upper surfaces of the electrode layers) exposed in the opening portion.

The surface roughness of each electrode layer will be described in more detail.

(a) The surface roughness of the electrode layer forming the narrowest part between the signal electrode and the ground electrode is lower than the surface roughness of at least another electrode layer.

In this configuration, decreasing the surface roughness of the electrode in a part in which the electric field is concentrated can significantly reduce a conductor loss of the electrode, and a high-frequency characteristic can be improved.

In order to further increase this effect, in the electrode layer forming the narrowest part between the signal electrode and the ground electrode, surface roughness of a side surface 30a where the signal electrode and the ground electrode face each other is set to be lower than surface roughness of an upper surface 30b of the electrode layer. This further contributes to reduction of the conductor loss.

Such an electrode layer forming the narrowest part between the signal electrode and the ground electrode is an electrode layer closest to the optical waveguide and is generally the electrode layer 30 of the lowermost tier as illustrated in FIGS. 1 to 5. Particularly, in a case where the electrode layer 30 of the lowermost tier is the narrowest part between the signal electrode and the ground electrode, a resin layer 5 and the side surface 30a of the electrode layer come into contact with each other in a case where the resin layer 5 that covers the optical waveguide 10 is disposed as illustrated in FIG. 5. In some cases, the upper surface 30b of the electrode layer is also in contact with the resin layer 5. In forming the resin layer, the surface roughness of the side surface and the upper surface of the electrode layer needs to be decreased in order to suppress a state where air bubbles in a liquid resin after coating remain on the side surface or the upper surface of the electrode layer.

Specifically, in the electrode layer forming the narrowest part between the signal electrode and the ground electrode, surface roughness R of the upper surface 30b of the electrode layer is in a range of 0.1 nm to 100 nm, and the surface roughness R of the side surface 30a where the signal electrode and the ground electrode face each other is in a range of 0.05 nm to 50 nm. The surface roughness of the side surface 30a of the electrode layer is lower than the surface roughness of the upper surface 30b of the electrode layer.

(b) The surface roughness of at least one electrode layer among the plurality of tiers of electrode layers is lower than surface roughness of a part in which a feeding line is connected to the signal electrode and the ground electrode by bonding.

By increasing the surface roughness of a bonding location, connection strength between a wire or a flip-chip and the electrode layer can be increased.

The bonding location is normally present on an upper surface of the electrode. Thus, the surface roughness of the upper surface of the electrode layer of the uppermost tier is increased. Consequently, it can be said that the surface roughness of the side surface where the signal electrode and the ground electrode face each other is lower than the surface roughness of the upper surface of the electrode layer of the uppermost tier.

However, even in the electrode layer of the uppermost tier, a skin effect causes the modulation signal to be concentrated near a surface of the electrode as a frequency of the modulation signal is increased. Thus, since the surface roughness increases the conductor loss (propagation loss), it is preferable to decrease the surface roughness.

Thus, as illustrated in the plan view in FIG. 6 (a diagram of a plan view of FIG. 1), in a case of connecting the electrode layer of the uppermost tier to another electrode or a terminal by bonding, it can be configured to increase the surface roughness of only a bonding location 6 formed on a part of the electrode of the uppermost tier.

While the location in which the surface roughness is increased has been described as a part of the surface of the electrode, the surface roughness of the entire surface of the electrode layer of the uppermost tier including the bonding location can be increased. Such a configuration is particularly suitable for the bias electrode to which a DC voltage is applied.

The location in which the surface roughness is increased may be formed on the signal electrode instead of the ground electrode, and the substrate may be either an X-cut substrate or a Z-cut substrate.

Specifically, in order to increase bonding connection strength, the roughness of the upper surface of the electrode layer of the uppermost tier is set to be in a range of 100 nm to 1000 nm. Of course, the bias electrode is not restricted to the upper limit value.

In the electrode layer 31 other than the electrode layer forming the narrowest part between the signal electrode and the ground electrode, surface roughness of a side surface 31a where the signal electrode and the ground electrode face each other is set to be in a range of 0.05 nm to 200 nm in order to reduce the conductor loss. The surface roughness of the side surface 31a of the electrode layer is lower than surface roughness of an upper surface 31b of the electrode layer.

Next, examples of applying the optical waveguide device of the present invention to an optical modulation device and an optical transmission apparatus will be described. While an optical modulation device incorporating the optical waveguide device using the rib optical waveguide in FIG. 1 will be described below, the present invention is not limited to this and is also applicable to a joint device, a sensor device, and the like for an optical phase modulator, an optical modulator having a polarization combining function, an optical waveguide device in which more Mach-Zehnder type optical waveguides are integrated, and an optical waveguide device formed of another material such as silicon. The present invention is also applicable to a high bandwidth-coherent driver modulator (HB-CDM).

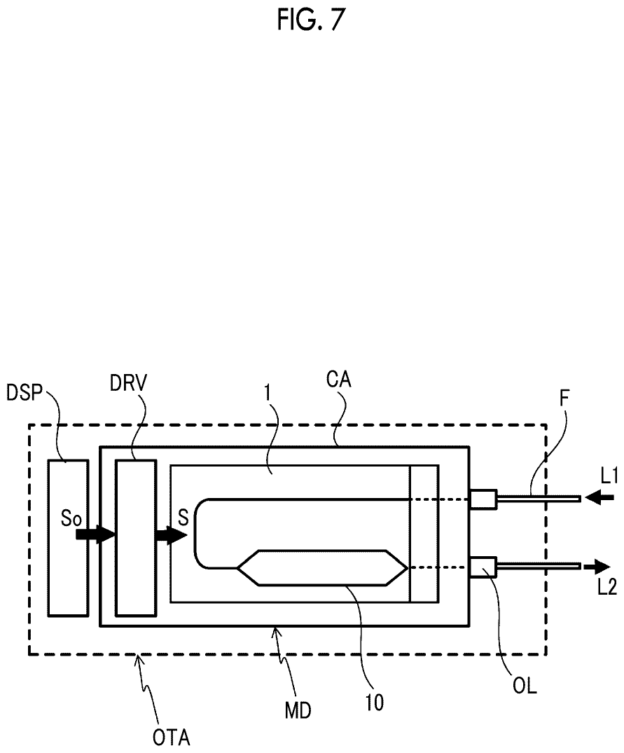

As illustrated in FIG. 7, the optical waveguide device includes the optical waveguide 10 formed on the substrate 1 and a modulation electrode (not illustrated) that modulates the light wave propagating through the optical waveguide 10, and is accommodated inside a case CA. An optical modulation device MD can also be configured by providing an optical fiber (F) through which a light wave is input into the optical waveguide or output from the optical waveguide. In FIG. 7, the optical fiber F is optically coupled to the optical waveguide 10 inside the optical waveguide device using an optical block 3 including an optical lens, a lens barrel OL, and the like. The present invention is not limited to this, and the optical fiber may be introduced into the case through a through-hole that penetrates through a side wall of the case. The optical fiber may be directly joined to an optical component or the substrate, or the optical fiber having a lens function in an end portion of the optical fiber may be optically coupled to the optical waveguide inside the optical waveguide device.

An optical transmission apparatus OTA can be configured by connecting, to the optical modulation device MD, an electronic circuit (digital signal processor DSP) that outputs a modulation signal So causing the optical modulation device MD to perform a modulation operation. In order to obtain a modulation signal S to be applied to the optical waveguide device, the modulation signal So output from the digital signal processor DSP needs to be amplified. Thus, in FIG. 7, the modulation signal is amplified using a driver circuit DRV. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit.

### INDUSTRIAL APPLICABILITY

As described above, according to the present invention, an optical waveguide device that has an excellent high-frequency characteristic and that is also favorable for forming a pattern of a resin layer covering an optical waveguide and bonding a feeding line to an electrode can be provided. An optical modulation device and an optical transmission apparatus using the optical waveguide device can also be provided.

### REFERENCE SIGNS LIST

1 Substrate (thin plate, film body) on which optical waveguide is formed
10, 11 Optical waveguide
30, 31 Electrode layer
30a, 31a Side surface of electrode layer
30b, 31b Upper surface of electrode layer
F Optical fiber
OL Lens barrel
CA Case
MD Optical modulation device
DRV Driver circuit
DSP Digital signal processor
OTA Optical transmission apparatus

1. An optical waveguide device comprising:
an optical waveguide formed on a substrate; and
a signal electrode and a ground electrode disposed on the substrate,
wherein each electrode of the signal electrode and the ground electrode is formed with a plurality of tiers of electrode layers excluding an underlayer, and
at least two electrode layers among the plurality of tiers of electrode layers have different surface roughness.

2. The optical waveguide device according to claim 1,
wherein surface roughness of an electrode layer forming a narrowest part between the signal electrode and the ground electrode is lower than surface roughness of at least another electrode layer.

3. The optical waveguide device according to claim 1 or 2,
wherein surface roughness of at least one electrode layer among the plurality of tiers of electrode layers is lower than surface roughness of a part in which a feeding line is connected to the signal electrode and the ground electrode by bonding.

4. The optical waveguide device according to claim 2,
wherein the electrode layer forming the narrowest part between the signal electrode and the ground electrode is an electrode layer of a lowermost tier.

5. The optical waveguide device according to claim 2,
wherein in the electrode layer forming the narrowest part between the signal electrode and the ground electrode, surface roughness of a side surface where the signal electrode and the ground electrode face each other is lower than surface roughness of an upper surface of the electrode layer.

6. The optical waveguide device according to claim 1,
wherein surface roughness of a side surface where the signal electrode and the ground electrode face each other is lower than surface roughness of an upper surface of an electrode layer of an uppermost tier.

7. The optical waveguide device according to claim 1,
wherein in an electrode layer forming a narrowest part between the signal electrode and the ground electrode, surface roughness of an upper surface of the electrode layer is in a range of 0.1 nm to 100 nm.

8. The optical waveguide device according to claim 1,
wherein in an electrode layer forming a narrowest part between the signal electrode and the ground electrode, surface roughness of a side surface where the signal electrode and the ground electrode face each other is lower than surface roughness of an upper surface of the electrode layer.

9. The optical waveguide device according to claim 1,
wherein roughness of an upper surface of an electrode layer of an uppermost tier is in a range of 100 nm to 1000 nm.

10. The optical waveguide device according to claim 1,
wherein in an electrode layer other than an electrode layer forming a narrowest part between the signal electrode and the ground electrode, surface roughness of a side surface where the signal electrode and the ground electrode face each other is lower than surface roughness of an upper surface of the electrode layer.

11. An optical modulation device comprising:
the optical waveguide device according to any one of claims 1 to 10;
a case accommodating the optical waveguide device; and
an optical fiber through which a light wave is input into the optical waveguide or output from the optical waveguide.

12. The optical modulation device according to claim 11,
wherein the optical waveguide device includes a modulation electrode that modulates the light wave propagating through the optical waveguide, and
an electronic circuit that amplifies a modulation signal to be input into the modulation electrode of the optical waveguide device is provided inside the case.

13. An optical transmission apparatus comprising:
the optical modulation device according to claim 11 or 12; and
an electronic circuit that outputs a modulation signal causing the optical modulation device to perform a modulation operation.
